(19) United States
(12) Patent Application Publication
(10) Pub. No.: US 2018/0356954 A1
(43) Pub. Date: Dec. 13, 2018

(54) MOBILE TERMINAL AND METHOD FOR CONTROLLING THE SAME

(71) Applicant: LG ELECTRONICS INC., Seoul (KR)

(72) Inventors: Juha HYUN, Seoul (KR); Eunhye KIM, Seoul (KR); Cheongha PARK, Seoul (KR); Juhye LEE, Seoul (KR)

(73) Assignee: LG ELECTRONICS INC., Seoul (KR)

(21) Appl. No.: 15/802,736

(22) Filed: Nov. 3, 2017

(30) Foreign Application Priority Data
Jun. 13, 2017 (KR) 10-2017-0074229

(51) Int. Cl. G06F 3/0488; G06F 3/0481; G06F 3/0482; H04W 4/18; H04W 68/06

(52) U.S. Cl. CPC G06F 3/0488; G06F 3/04817; H04W 68/06; H04W 4/18; G06F 3/0482

(57) ABSTRACT

A mobile terminal including a touch screen configured to display a folder icon of a folder including a plurality of applications; and a controller configured to in response to a first force touch input having a specific touch strength applied to the folder icon, display summary information of an event which occurred in at least one application of the plurality of applications, and in response to a first non-force touch input applied after the first force touch input, display a notification window including detailed information of the event which has occurred in at least one application of the plurality of applications.

### CROSS-REFERENCE TO RELATED APPLICATION

Pursuant to 35 U.S.C. § 119(a), this application claims the benefit of earlier filing date and right of priority to Korean Application No. 10-2017-0074229, filed on Jun. 13, 2017, the contents of which is incorporated by reference herein in its entirety.

### BACKGROUND OF THE INVENTION

### 1. Field of the Invention

The present disclosure relates to a mobile terminal capable of effectively managing various types of notification information generated in the mobile terminal, and a method for controlling the same.

### 2. Background of the Invention

Terminals may be generally classified as mobile/portable terminals or stationary terminals. Mobile terminals may also be classified as handheld terminals or vehicle mounted terminals.

Mobile terminals have become increasingly more functional. Examples of such functions include data and voice communications, capturing images and video via a camera, recording audio, playing music files via a speaker system, and displaying images and video on a display. More recently, mobile terminals have been configured to receive broadcast and multicast signals which permit viewing of content such as videos and television programs.

As functions of the terminal become more diversified, the terminal can support more complicated functions such as capturing images or video, reproducing music or video files, playing games, receiving broadcast signals, and the like. By comprehensively and collectively implementing such functions, the mobile terminal may be embodied in the form of a multimedia player or a device. Efforts are ongoing to support and increase the functionality of mobile terminals. Such efforts include software and hardware improvements, as well as changes and improvements in the structural components.

When an event occurs in an application installed in a terminal, the terminal can provide notification information to a user of the terminal in order to inform the user about the occurrence of the event. However, as the number of applications installed in the terminal is increased, a large amount of notification information is indiscriminately provided. Thus, the user of the terminal may miss essential notification information among the large amount of notification information.

### SUMMARY OF THE INVENTION

Therefore, an aspect of the detailed description is to provide a user interface for effectively managing notification information.

Another aspect of the detailed description is to provide a method for quickly reading unnecessary notification information.

To achieve these and other advantages and in accordance with the purpose of this specification, as embodied and broadly described herein, a mobile terminal includes: a touch screen displaying a folder icon of a folder including a plurality of applications; and a controller outputting summary information of an event which occurs in at least one of the plurality of applications, in response to a first touch input satisfying a condition related to a touch strength, applied to the folder icon and outputting a notification window including detailed information of the event which has occurred in at least one of the plurality of applications, in response to a second touch input applied continuously after the first touch input in when the summary information is output.

To achieve these and other advantages and in accordance with the purpose of this specification, as embodied and broadly described herein, a method for controlling a mobile terminal includes: displaying a folder icon of a folder including a plurality of applications; outputting summary information of an event which occurs in at least one of the plurality of applications in response to a first touch input satisfying a condition related to a touch strength, applied to the folder icon; and outputting a notification window including detailed information of the event which has occurred in at least one of the plurality of applications, in response to a second touch input applied continuously after the first touch input in when the summary information is output.

Further scope of applicability of the present application will become more apparent from the detailed description given hereinafter. However, it should be understood that the detailed description and specific examples, while indicating preferred embodiments of the invention, are given by way of illustration only, since various changes and modifications within the scope of the invention will become apparent to those skilled in the art from the detailed description.

### BRIEF DESCRIPTION OF THE DRAWINGS

The accompanying drawings, which are included to provide a further understanding of the invention and are incorporated in and constitute a part of this specification, illustrate exemplary embodiments and together with the description serve to explain the principles of the invention.

In the drawings:

FIG. 1A is a block diagram of a mobile terminal according to an embodiment of the present disclosure.

FIGS. 1B and 1C are conceptual views of one example of the mobile terminal, viewed from different directions;

FIG. 2 is a flow chart illustrating a method for providing a user interface managing notification information of an event that occurs in a mobile terminal according to an embodiment of the present disclosure.

FIGS. 3A and 3B are conceptual views illustrating the user interface of FIG. 2.

FIGS. 4A and 4B are conceptual views illustrating a method of executing a storage function.

FIGS. 5A and 5B are conceptual views illustrating a method of providing a preview screen using detailed information included in a notification window.

FIG. 6 is a conceptual view illustrating a method of moving between notification windows generated by different folders.

FIG. 7 is a conceptual view illustrating a method of outputting a notification window using a state display region.

### DETAILED DESCRIPTION OF THE INVENTION

Description will now be given in detail of the exemplary embodiments, with reference to the accompanying drawings. For the sake of brief description with reference to the drawings, the same or equivalent components will be provided with the same reference numbers, and description thereof will not be repeated.

Hereinafter, a method of providing a user interface managing notification information of an event that occurs in a mobile terminal according to an embodiment of the present disclosure will be described.

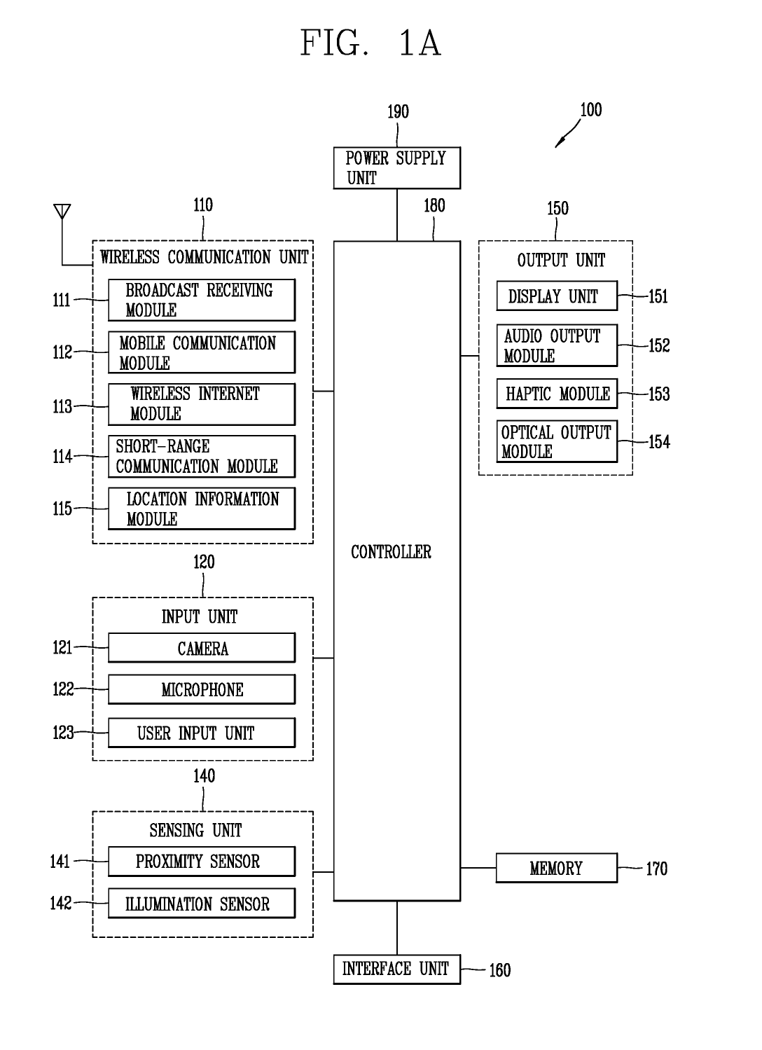

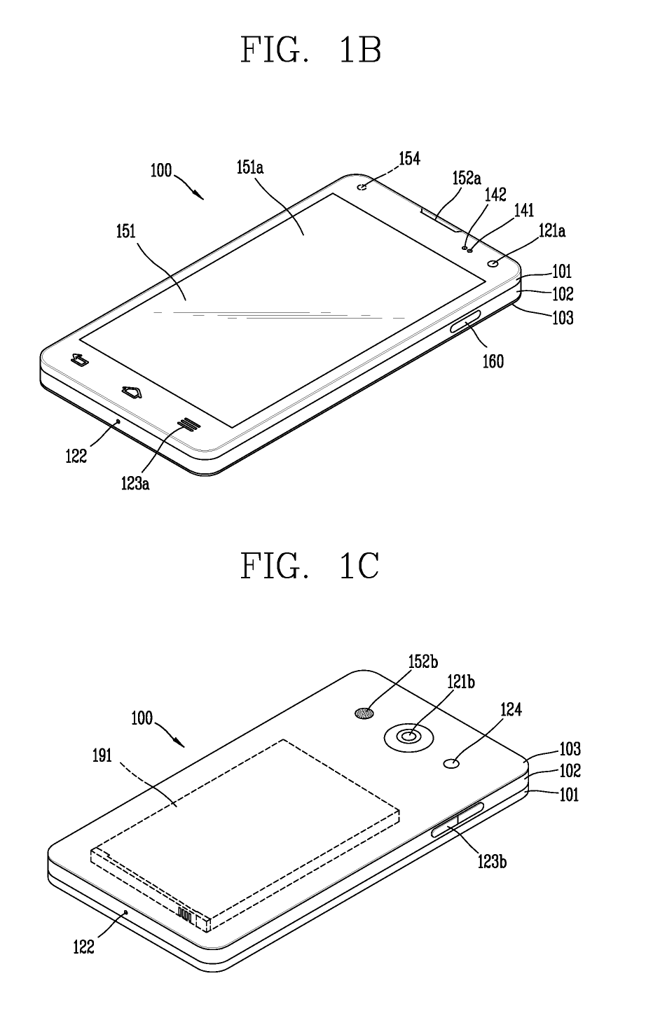

Reference is now made to FIGS. 1A-1C, where FIG. 1A is a block diagram of a mobile terminal in accordance with the present disclosure, and FIGS. 1B and 1C are conceptual views of one example of the mobile terminal, viewed from different directions. The mobile terminal 100 is shown having components such as a wireless communication unit 110, an input unit 120, a sensing unit 140, an output unit 150, an interface unit 160, a memory 170, a controller 180, and a power supply unit 190. Implementing all of the illustrated components is not a requirement, and that greater or fewer components may alternatively be implemented.

Referring now to FIG. 1A, the mobile terminal 100 is shown having wireless communication unit 110 configured with several commonly implemented components. The wireless communication unit 110 typically includes one or more modules which permit communications such as wireless communications between the mobile terminal 100 and a wireless communication system, communications between the mobile terminal 100 and another mobile terminal, communications between the mobile terminal 100 and an external server. Further, the wireless communication unit 110 typically includes one or more modules which connect the mobile terminal 100 to one or more networks. To facilitate such communications, the wireless communication unit 110 includes one or more of a broadcast receiving module 111, a mobile communication module 112, a wireless Internet module 113, a short-range communication module 114, and a location information module 115.

The input unit 120 includes a camera 121 for obtaining images or video, a microphone 122, which is one type of audio input device for inputting an audio signal, and a user input unit 123 (for example, a touch key, a push key, a mechanical key, a soft key, and the like) for allowing a user to input information. Data (for example, audio, video, image, and the like) is obtained by the input unit 120 and may be analyzed and processed by controller 180 according to device parameters, user commands, and combinations thereof.

The sensing unit 140 is typically implemented using one or more sensors configured to sense internal information of the mobile terminal, the surrounding environment of the mobile terminal, user information, and the like. For example, in FIG. 1A, the sensing unit 140 is shown having a proximity sensor 141 and an illumination sensor 142.

If desired, the sensing unit 140 may alternatively or additionally include other types of sensors or devices, such as a touch sensor, an acceleration sensor, a magnetic sensor, a G-sensor, a gyroscope sensor, a motion sensor, an RGB sensor, an infrared (IR) sensor, a finger scan sensor, a ultrasonic sensor, an optical sensor (for example, camera 121), a microphone 122, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

The output unit 150 is typically configured to output various types of information, such as audio, video, tactile output, and the like. The output unit 150 is shown having a display unit 151, an audio output module 152, a haptic module 153, and an optical output module 154. The display unit 151 may have an inter-layered structure or an integrated structure with a touch sensor in order to facilitate a touch screen. The touch screen may provide an output interface between the mobile terminal 100 and a user, as well as function as the user input unit 123 which provides an input interface between the mobile terminal 100 and the user.

The interface unit 160 serves as an interface with various types of external devices that can be coupled to the mobile terminal 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the mobile terminal 100 may perform assorted control functions associated with a connected external device, in response to the external device being connected to the interface unit 160.

The memory 170 is typically implemented to store data to support various functions or features of the mobile terminal 100. For instance, the memory 170 may be configured to store application programs executed in the mobile terminal 100, data or instructions for operations of the mobile terminal 100, and the like. Some of these application programs may be downloaded from an external server via wireless communication. Other application programs may be installed within the mobile terminal 100 at time of manufacturing or shipping, which is typically the case for basic functions of the mobile terminal 100 (for example, receiving a call, placing a call, receiving a message, sending a message, and the like). It is common for application programs to be stored in the memory 170, installed in the mobile terminal 100, and executed by the controller 180 to perform an operation (or function) for the mobile terminal 100.

The controller 180 typically functions to control overall operation of the mobile terminal 100, in addition to the operations associated with the application programs. The controller 180 processes signals, data, information and the like input or output through the above-mentioned components and/or runs application programs saved in the memory 170, thereby processing or providing a user with appropriate information and/or functions.

The controller 180 can provide or process information or functions appropriate for a user by processing signals, data, information and the like, which are input or output by the various components depicted in FIG. 1A, or activating application programs stored in the memory 170. As one example, the controller 180 controls some or all of the components illustrated in FIGS. 1A-1C according to the execution of an application program that have been stored in the memory 170.

The power supply unit 190 can be configured to receive external power or provide internal power in order to supply appropriate power required for operating elements and components included in the mobile terminal 100. The power supply unit 190 may include a battery, and the battery may be configured to be embedded in the terminal body, or configured to be detachable from the terminal body.

At least one portion of the respective components mentioned in the foregoing description can cooperatively operate to embody operations, controls or controlling methods of the mobile terminal according to various embodiments of the present invention mentioned in the following description. Moreover, the operations, controls or controlling methods of the mobile terminal can be embodied in the mobile terminal by running at least one or more application programs saved in the memory 170.

Referring still to FIG. 1A, various components depicted in this figure will now be described in more detail. Regarding the wireless communication unit 110, the broadcast receiving module 111 is typically configured to receive a broadcast signal and/or broadcast associated information from an external broadcast managing entity via a broadcast channel. The broadcast channel may include a satellite channel, a terrestrial channel, or both. In some embodiments, two or more broadcast receiving modules 111 may be utilized to facilitate simultaneously receiving of two or more broadcast channels, or to support switching among broadcast channels.

The broadcast managing entity may be implemented using a server or system which generates and transmits a broadcast signal and/or broadcast associated information, or a server which receives a pre-generated broadcast signal and/or broadcast associated information, and sends such items to the mobile terminal. The broadcast signal may be implemented using any of a TV broadcast signal, a radio broadcast signal, a data broadcast signal, and combinations thereof, among others. The broadcast signal in some cases may further include a data broadcast signal combined with a TV or radio broadcast signal.

The broadcast signal may be encoded according to any of a variety of technical standards or broadcasting methods (for example, International Organization for Standardization (ISO), International Electrotechnical Commission (IEC), Digital Video Broadcast (DVB), Advanced Television Systems Committee (ATSC), and the like) for transmission and reception of digital broadcast signals. The broadcast receiving module 111 can receive the digital broadcast signals using a method appropriate for the transmission method utilized.

Examples of broadcast associated information may include information associated with a broadcast channel, a broadcast program, a broadcast event, a broadcast service provider, or the like. The broadcast associated information may also be provided via a mobile communication network, and in this instance, received by the mobile communication module 112.

The broadcast associated information may be implemented in various formats. For instance, broadcast associated information may include an Electronic Program Guide (EPG) of Digital Multimedia Broadcasting (DMB), an Electronic Service Guide (ESG) of Digital Video Broadcast-Handheld (DVB-H), and the like. Broadcast signals and/or broadcast associated information received via the broadcast receiving module 111 may be stored in a suitable device, such as a memory 170.

The mobile communication module 112 can transmit and/or receive wireless signals to and from one or more network entities. Typical examples of a network entity include a base station, an external mobile terminal, a server, and the like. Such network entities form part of a mobile communication network, which is constructed according to technical standards or communication methods for mobile communications (for example, Global System for Mobile Communication (GSM), Code Division Multi Access (CDMA), CDMA2000 (Code Division Multi Access 2000), EV-DO (Enhanced Voice-Data Optimized or Enhanced Voice-Data Only), Wideband CDMA (WCDMA), High Speed Downlink Packet access (HSDPA), HSUPA (High Speed Uplink Packet Access), Long Term Evolution (LTE), LTE-A (Long Term Evolution-Advanced), and the like). Examples of wireless signals transmitted and/or received via the mobile communication module 112 include audio call signals, video (telephony) call signals, or various formats of data to support communication of text and multimedia messages.

The wireless Internet module 113 is configured to facilitate wireless Internet access. This module may be internally or externally coupled to the mobile terminal 100. The wireless Internet module 113 may transmit and/or receive wireless signals via communication networks according to wireless Internet technologies. Examples of such wireless Internet access include Wireless LAN (WLAN), Wireless Fidelity (Wi-Fi), Wi-Fi Direct, Digital Living Network Alliance (DLNA), Wireless Broadband (WiBro), Worldwide Interoperability for Microwave Access (WiMAX), High Speed Downlink Packet Access (HSDPA), HSUPA (High Speed Uplink Packet Access), Long Term Evolution (LTE), LTE-A (Long Term Evolution-Advanced), and the like. The wireless Internet module 113 may transmit/receive data according to one or more of such wireless Internet technologies, and other Internet technologies as well.

In some embodiments, when the wireless Internet access is implemented according to, for example, WiBro, HSDPA, HSUPA, GSM, CDMA, WCDMA, LTE, LTE-A and the like, as part of a mobile communication network, the wireless Internet module 113 performs such wireless Internet access. As such, the Internet module 113 may cooperate with, or function as, the mobile communication module 112.

The short-range communication module 114 is configured to facilitate short-range communications. Suitable technologies for implementing such short-range communications include BLUETOOTH™, Radio Frequency IDentification (RFID), Infrared Data Association (IrDA), Ultra-WideBand (UWB), ZigBee, Near Field Communication (NFC), Wireless-Fidelity (Wi-Fi), Wi-Fi Direct, Wireless USB (Wireless Universal Serial Bus), and the like. The short-range communication module 114 in general supports wireless communications between the mobile terminal 100 and a wireless communication system, communications between the mobile terminal 100 and another mobile terminal 100, or communications between the mobile terminal and a network where another mobile terminal 100 (or an external server) is located, via wireless area networks. One example of the wireless area networks is a wireless personal area networks.

In some embodiments, another mobile terminal (which may be configured similarly to mobile terminal 100) may be a wearable device, for example, a smart watch, a smart glass or a head mounted display (HMD), which can exchange data with the mobile terminal 100 (or otherwise cooperate with the mobile terminal 100). The short-range communication module 114 may sense or recognize the wearable device, and permit communication between the wearable device and the mobile terminal 100. In addition, when the sensed wearable device is a device which is authenticated to communicate with the mobile terminal 100, the controller 180, for example, may cause transmission of data processed in the mobile terminal 100 to the wearable device via the short-range communication module 114. Hence, a user of the wearable device may use the data processed in the mobile terminal 100 on the wearable device. For example, when a call is received in the mobile terminal 100, the user may answer the call using the wearable device. Also, when a message is received in the mobile terminal 100, the user can check the received message using the wearable device.

The location information module 115 is generally configured to detect, calculate, derive or otherwise identify a position of the mobile terminal. As an example, the location information module 115 includes a Global Position System (GPS) module, a Wi-Fi module, or both. If desired, the location information module 115 may alternatively or additionally function with any of the other modules of the wireless communication unit 110 to obtain data related to the position of the mobile terminal.

As one example, when the mobile terminal uses a GPS module, a position of the mobile terminal may be acquired using a signal sent from a GPS satellite. As another example, when the mobile terminal uses the Wi-Fi module, a position of the mobile terminal can be acquired based on information related to a wireless access point (AP) which transmits or receives a wireless signal to or from the Wi-Fi module.

The input unit 120 may be configured to permit various types of input to the mobile terminal 120. Examples of such input include audio, image, video, data, and user input. Image and video input is often obtained using one or more cameras 121. Such cameras 121 may process image frames of still pictures or video obtained by image sensors in a video or image capture mode. The processed image frames can be displayed on the display unit 151 or stored in memory 170. In some cases, the cameras 121 may be arranged in a matrix configuration to permit a plurality of images having various angles or focal points to be input to the mobile terminal 100. As another example, the cameras 121 may be located in a stereoscopic arrangement to acquire left and right images for implementing a stereoscopic image.

The microphone 122 is generally implemented to permit audio input to the mobile terminal 100. The audio input can be processed in various manners according to a function being executed in the mobile terminal 100. If desired, the microphone 122 may include assorted noise removing algorithms to remove unwanted noise generated in the course of receiving the external audio.

The user input unit 123 is a component that permits input by a user. Such user input may enable the controller 180 to control operation of the mobile terminal 100. The user input unit 123 may include one or more of a mechanical input element (for example, a key, a button located on a front and/or rear surface or a side surface of the mobile terminal 100, a dome switch, a jog wheel, a jog switch, and the like), or a touch-sensitive input, among others. As one example, the touch-sensitive input may be a virtual key or a soft key, which is displayed on a touch screen through software processing, or a touch key which is located on the mobile terminal at a location that is other than the touch screen. Further, the virtual key or the visual key may be displayed on the touch screen in various shapes, for example, graphic, text, icon, video, or a combination thereof.

The sensing unit 140 is generally configured to sense one or more of internal information of the mobile terminal, surrounding environment information of the mobile terminal, user information, or the like. The controller 180 generally cooperates with the sending unit 140 to control operation of the mobile terminal 100 or execute data processing, a function or an operation associated with an application program installed in the mobile terminal based on the sensing provided by the sensing unit 140. The sensing unit 140 may be implemented using any of a variety of sensors, some of which will now be described in more detail.

The proximity sensor 141 may include a sensor to sense presence or absence of an object approaching a surface, or an object located near a surface, by using an electromagnetic field, infrared rays, or the like without a mechanical contact. The proximity sensor 141 may be arranged at an inner region of the mobile terminal covered by the touch screen, or near the touch screen.

The proximity sensor 141, for example, may include any of a transmissive type photoelectric sensor, a direct reflective type photoelectric sensor, a mirror reflective type photoelectric sensor, a high-frequency oscillation proximity sensor, a capacitance type proximity sensor, a magnetic type proximity sensor, an infrared rays proximity sensor, and the like. When the touch screen is implemented as a capacitance type, the proximity sensor 141 can sense proximity of a pointer relative to the touch screen by changes of an electromagnetic field, which is responsive to an approach of an object with conductivity. In this instance, the touch screen (touch sensor) may also be categorized as a proximity sensor.

The term “proximity touch” will often be referred to herein to denote the scenario in which a pointer is positioned to be proximate to the touch screen without contacting the touch screen. The term “contact touch” will often be referred to herein to denote the scenario in which a pointer makes physical contact with the touch screen. For the position corresponding to the proximity touch of the pointer relative to the touch screen, such position will correspond to a position where the pointer is perpendicular to the touch screen. The proximity sensor 141 may sense proximity touch, and proximity touch patterns (for example, distance, direction, speed, time, position, moving status, and the like).

In general, controller 180 processes data corresponding to proximity touches and proximity touch patterns sensed by the proximity sensor 141, and cause output of visual information on the touch screen. In addition, the controller 180 can control the mobile terminal 100 to execute different operations or process different data according to whether a touch with respect to a point on the touch screen is either a proximity touch or a contact touch.

A touch sensor can sense a touch applied to the touch screen, such as display unit 151, using any of a variety of touch methods. Examples of such touch methods include a resistive type, a capacitive type, an infrared type, and a magnetic field type, among others. As one example, the touch sensor may be configured to convert changes of pressure applied to a specific part of the display unit 151, or convert capacitance occurring at a specific part of the display unit 151, into electric input signals. The touch sensor may also be configured to sense not only a touched position and a touched area, but also touch pressure and/or touch capacitance. A touch object is generally used to apply a touch input to the touch sensor. Examples of typical touch objects include a finger, a touch pen, a stylus pen, a pointer, or the like.

When a touch input is sensed by a touch sensor, corresponding signals may be transmitted to a touch controller. The touch controller may process the received signals, and then transmit corresponding data to the controller 180. Accordingly, the controller 180 can sense which region of the display unit 151 has been touched. Here, the touch controller may be a component separate from the controller 180, the controller 180, and combinations thereof.

In some embodiments, the controller 180 can execute the same or different controls according to a type of touch object that touches the touch screen or a touch key provided in addition to the touch screen. Whether to execute the same or different control according to the object which provides a touch input may be decided based on a current operating state of the mobile terminal 100 or a currently executed application program, for example.

The touch sensor and the proximity sensor may be implemented individually, or in combination, to sense various types of touches. Such touches includes a short (or tap) touch, a long touch, a multi-touch, a drag touch, a flick touch, a pinch-in touch, a pinch-out touch, a swipe touch, a hovering touch, and the like.

If desired, an ultrasonic sensor may be implemented to recognize position information relating to a touch object using ultrasonic waves. The controller 180, for example, may calculate a position of a wave generation source based on information sensed by an illumination sensor and a plurality of ultrasonic sensors. Since light is much faster than ultrasonic waves, the time for which the light reaches the optical sensor is much shorter than the time for which the ultrasonic wave reaches the ultrasonic sensor. The position of the wave generation source may be calculated using this fact. For instance, the position of the wave generation source may be calculated using the time difference from the time that the ultrasonic wave reaches the sensor based on the light as a reference signal.

The camera 121 typically includes at least one a camera sensor (CCD, CMOS etc.), a photo sensor (or image sensors), and a laser sensor. Implementing the camera 121 with a laser sensor may allow detection of a touch of a physical object with respect to a 3D stereoscopic image. The photo sensor may be laminated on, or overlapped with, the display device. The photo sensor may be configured to scan movement of the physical object in proximity to the touch screen. In more detail, the photo sensor may include photo diodes and transistors at rows and columns to scan content received at the photo sensor using an electrical signal which changes according to the quantity of applied light. Namely, the photo sensor may calculate the coordinates of the physical object according to variation of light to thus obtain position information of the physical object.

The display unit 151 is generally configured to output information processed in the mobile terminal 100. For example, the display unit 151 may display execution screen information of an application program executing at the mobile terminal 100 or user interface (UI) and graphic user interface (GUI) information in response to the execution screen information.

In some embodiments, the display unit 151 may be implemented as a stereoscopic display unit for displaying stereoscopic images. A typical stereoscopic display unit may employ a stereoscopic display scheme such as a stereoscopic scheme (a glass scheme), an auto-stereoscopic scheme (glassless scheme), a projection scheme (holographic scheme), or the like.

In general, a 3D stereoscopic image may include a left image (e.g., a left eye image) and a right image (e.g., a right eye image). According to how left and right images are combined into a 3D stereoscopic image, a 3D stereoscopic imaging method can be divided into a top-down method in which left and right images are located up and down in a frame, an L-to-R (left-to-right or side by side) method in which left and right images are located left and right in a frame, a checker board method in which fragments of left and right images are located in a tile form, an interlaced method in which left and right images are alternately located by columns or rows, and a time sequential (or frame by frame) method in which left and right images are alternately displayed on a time basis.

Also, as for a 3D thumbnail image, a left image thumbnail and a right image thumbnail can be generated from a left image and a right image of an original image frame, respectively, and then combined to generate a single 3D thumbnail image. In general, the term “thumbnail” may be used to refer to a reduced image or a reduced still image. A generated left image thumbnail and right image thumbnail may be displayed with a horizontal distance difference there between by a depth corresponding to the disparity between the left image and the right image on the screen, thereby providing a stereoscopic space sense.

A left image and a right image required for implementing a 3D stereoscopic image may be displayed on the stereoscopic display unit using a stereoscopic processing unit. The stereoscopic processing unit can receive the 3D image and extract the left image and the right image, or can receive the 2D image and change it into a left image and a right image.

The audio output module 152 is generally configured to output audio data. Such audio data may be obtained from any of a number of different sources, such that the audio data may be received from the wireless communication unit 110 or may have been stored in the memory 170. The audio data may be output during modes such as a signal reception mode, a call mode, a record mode, a voice recognition mode, a broadcast reception mode, and the like. The audio output module 152 can provide audible output related to a particular function (e.g., a call signal reception sound, a message reception sound, etc.) performed by the mobile terminal 100. The audio output module 152 may also be implemented as a receiver, a speaker, a buzzer, or the like.

A haptic module 153 can be configured to generate various tactile effects that a user feels, perceive, or otherwise experience. A typical example of a tactile effect generated by the haptic module 153 is vibration. The strength, pattern and the like of the vibration generated by the haptic module 153 can be controlled by user selection or setting by the controller. For example, the haptic module 153 may output different vibrations in a combining manner or a sequential manner.

Besides vibration, the haptic module 153 can generate various other tactile effects, including an effect by stimulation such as a pin arrangement vertically moving to contact skin, a spray force or suction force of air through a jet orifice or a suction opening, a touch to the skin, a contact of an electrode, electrostatic force, an effect by reproducing the sense of cold and warmth using an element that can absorb or generate heat, and the like.

The haptic module 153 can also be implemented to allow the user to feel a tactile effect through a muscle sensation such as the user's fingers or arm, as well as transferring the tactile effect through direct contact. Two or more haptic modules 153 may be provided according to the particular configuration of the mobile terminal 100.

An optical output module 154 can output a signal for indicating an event generation using light of a light source. Examples of events generated in the mobile terminal 100 may include message reception, call signal reception, a missed call, an alarm, a schedule notice, an email reception, information reception through an application, and the like.

A signal output by the optical output module 154 may be implemented so the mobile terminal emits monochromatic light or light with a plurality of colors. The signal output may be terminated as the mobile terminal senses that a user has checked the generated event, for example.

The interface unit 160 serves as an interface for external devices to be connected with the mobile terminal 100. For example, the interface unit 160 can receive data transmitted from an external device, receive power to transfer to elements and components within the mobile terminal 100, or transmit internal data of the mobile terminal 100 to such external device. The interface unit 160 may include wired or wireless headset ports, external power supply ports, wired or wireless data ports, memory card ports, ports for connecting a device having an identification module, audio input/output (I/O) ports, video I/O ports, earphone ports, or the like.

The identification module may be a chip that stores various information for authenticating authority of using the mobile terminal 100 and may include a user identity module (UIM), a subscriber identity module (SIM), a universal subscriber identity module (USIM), and the like. In addition, the device having the identification module (also referred to herein as an “identifying device”) may take the form of a smart card. Accordingly, the identifying device can be connected with the terminal 100 via the interface unit 160.

When the mobile terminal 100 is connected with an external cradle, the interface unit 160 can serve as a passage to allow power from the cradle to be supplied to the mobile terminal 100 or may serve as a passage to allow various command signals input by the user from the cradle to be transferred to the mobile terminal there through. Various command signals or power input from the cradle may operate as signals for recognizing that the mobile terminal is properly mounted on the cradle.

The memory 170 can store programs to support operations of the controller 180 and store input/output data (for example, phonebook, messages, still images, videos, etc.). The memory 170 may store data related to various patterns of vibrations and audio which are output in response to touch inputs on the touch screen.

The memory 170 may include one or more types of storage mediums including a Flash memory, a hard disk, a solid state disk, a silicon disk, a multimedia card micro type, a card-type memory (e.g., SD or DX memory, etc.), a Random Access Memory (RAM), a Static Random Access Memory (SRAM), a Read-Only Memory (ROM), an Electrically Erasable Programmable Read-Only Memory (EEPROM), a Programmable Read-Only memory (PROM), a magnetic memory, a magnetic disk, an optical disk, and the like. The mobile terminal 100 may also be operated in relation to a network storage device that performs the storage function of the memory 170 over a network, such as the Internet.

The controller 180 can typically control the general operations of the mobile terminal 100. For example, the controller 180 can set or release a lock state for restricting a user from inputting a control command with respect to applications when a status of the mobile terminal meets a preset condition.

The controller 180 can also perform the controlling and processing associated with voice calls, data communications, video calls, and the like, or perform pattern recognition processing to recognize a handwriting input or a picture drawing input performed on the touch screen as characters or images, respectively. In addition, the controller 180 can control one or a combination of those components in order to implement various exemplary embodiments disclosed herein.

The power supply unit 190 receives external power or provide internal power and supply the appropriate power required for operating respective elements and components included in the mobile terminal 100. The power supply unit 190 may include a battery, which is typically rechargeable or be detachably coupled to the terminal body for charging.

The power supply unit 190 may include a connection port. The connection port may be configured as one example of the interface unit 160 to which an external charger for supplying power to recharge the battery is electrically connected. As another example, the power supply unit 190 may be configured to recharge the battery in a wireless manner without use of the connection port. In this example, the power supply unit 190 can receive power, transferred from an external wireless power transmitter, using at least one of an inductive coupling method which is based on magnetic induction or a magnetic resonance coupling method which is based on electromagnetic resonance. Various embodiments described herein may be implemented in a computer-readable medium, a machine-readable medium, or similar medium using, for example, software, hardware, or any combination thereof.

Referring now to FIGS. 1B and 1C, the mobile terminal 100 is described with reference to a bar-type terminal body. However, the mobile terminal 100 may alternatively be implemented in any of a variety of different configurations. Examples of such configurations include watch-type, clip-type, glasses-type, or as a folder-type, flip-type, slide-type, swing-type, and swivel-type in which two and more bodies are combined with each other in a relatively movable manner, and combinations thereof. Discussion herein will often relate to a particular type of mobile terminal (for example, bar-type, watch-type, glasses-type, and the like). However, such teachings with regard to a particular type of mobile terminal will generally apply to other types of mobile terminals as well.

The mobile terminal 100 will generally include a case (for example, frame, housing, cover, and the like) forming the appearance of the terminal. In this embodiment, the case is formed using a front case 101 and a rear case 102. Various electronic components are incorporated into a space formed between the front case 101 and the rear case 102. At least one middle case may be additionally positioned between the front case 101 and the rear case 102.

The display unit 151 is shown located on the front side of the terminal body to output information. As illustrated, a window 151a of the display unit 151 may be mounted to the front case 101 to form the front surface of the terminal body together with the front case 101.

In some embodiments, electronic components may also be mounted to the rear case 102. Examples of such electronic components include a detachable battery 191, an identification module, a memory card, and the like. Rear cover 103 is shown covering the electronic components, and this cover may be detachably coupled to the rear case 102. Therefore, when the rear cover 103 is detached from the rear case 102, the electronic components mounted to the rear case 102 are externally exposed.

As illustrated, when the rear cover 103 is coupled to the rear case 102, a side surface of the rear case 102 is partially exposed. In some cases, upon the coupling, the rear case 102 may also be completely shielded by the rear cover 103. In some embodiments, the rear cover 103 may include an opening for externally exposing a camera 121b or an audio output module 152b.

The cases 101, 102, 103 may be formed by injection-molding synthetic resin or may be formed of a metal, for example, stainless steel (STS), aluminum (Al), titanium (Ti), or the like. As an alternative to the example in which the plurality of cases form an inner space for accommodating components, the mobile terminal 100 may be configured such that one case forms the inner space. In this example, a mobile terminal 100 having a uni-body is formed so synthetic resin or metal extends from a side surface to a rear surface.

If desired, the mobile terminal 100 may include a waterproofing unit for preventing introduction of water into the terminal body. For example, the waterproofing unit may include a waterproofing member which is located between the window 151a and the front case 101, between the front case 101 and the rear case 102, or between the rear case 102 and the rear cover 103, to hermetically seal an inner space when those cases are coupled.

The mobile terminal 100 may be provided with the display unit 151, the first audio output unit 152a, the second audio output unit 152b, the proximity sensor 141, the illumination sensor 142, the optical output unit 154, the first camera 121a, the second camera 121b, the first manipulating unit 123a, the second manipulating unit 123b, the microphone 122, the interface unit 160, and the like.

FIGS. 1B and 1C depict certain components as arranged on the mobile terminal. However, alternative arrangements are possible and within the teachings of the instant disclosure. Some components may be omitted or rearranged. For example, the first manipulation unit 123a may be located on another surface of the terminal body, and the second audio output module 152b may be located on the side surface of the terminal body.

The display unit 151 outputs information processed in the mobile terminal 100. The display unit 151 may be implemented using one or more suitable display devices. Examples of such suitable display devices include a liquid crystal display (LCD), a thin film transistor-liquid crystal display (TFT-LCD), an organic light emitting diode (OLED), a flexible display, a 3-dimensional (3D) display, an e-ink display, and combinations thereof.

The display unit 151 may be implemented using two display devices, which can implement the same or different display technology. For instance, a plurality of the display units 151 may be arranged on one side, either spaced apart from each other, or these devices may be integrated, or these devices may be arranged on different surfaces.

The display unit 151 may also include a touch sensor which senses a touch input received at the display unit. When a touch is input to the display unit 151, the touch sensor may be configured to sense this touch and the controller 180, for example, may generate a control command or other signal corresponding to the touch. The content which is input in the touching manner may be a text or numerical value, or a menu item which can be indicated or designated in various modes.

The touch sensor may be configured in a form of a film having a touch pattern, disposed between the window 151a and a display on a rear surface of the window 151a, or a metal wire which is patterned directly on the rear surface of the window 151a. Alternatively, the touch sensor may be integrally formed with the display. For example, the touch sensor may be disposed on a substrate of the display or within the display.

The display unit 151 may also form a touch screen together with the touch sensor. Here, the touch screen may serve as the user input unit 123 (see FIG. 1A). Therefore, the touch screen may replace at least some of the functions of the first manipulation unit 123a. The first audio output module 152a may be implemented in the form of a speaker to output voice audio, alarm sounds, multimedia audio reproduction, and the like.

The window 151a of the display unit 151 will typically include an aperture to permit audio generated by the first audio output module 152a to pass. One alternative is to allow audio to be released along an assembly gap between the structural bodies (for example, a gap between the window 151a and the front case 101). In this instance, a hole independently formed to output audio sounds may not be seen or is otherwise hidden in terms of appearance, thereby further simplifying the appearance and manufacturing of the mobile terminal 100.

The optical output module 154 can be configured to output light for indicating an event generation. Examples of such events include a message reception, a call signal reception, a missed call, an alarm, a schedule notice, an email reception, information reception through an application, and the like. When a user has checked a generated event, the controller can control the optical output unit 154 to stop the light output.

The first camera 121a can process image frames such as still or moving images obtained by the image sensor in a capture mode or a video call mode. The processed image frames can then be displayed on the display unit 151 or stored in the memory 170. The first and second manipulation units 123a and 123b are examples of the user input unit 123, which may be manipulated by a user to provide input to the mobile terminal 100. The first and second manipulation units 123a and 123b may also be commonly referred to as a manipulating portion, and may employ any tactile method that allows the user to perform manipulation such as touch, push, scroll, or the like. The first and second manipulation units 123a and 123b may also employ any non-tactile method that allows the user to perform manipulation such as proximity touch, hovering, or the like.

FIG. 1B illustrates the first manipulation unit 123a as a touch key, but possible alternatives include a mechanical key, a push key, a touch key, and combinations thereof. Input received at the first and second manipulation units 123a and 123b may be used in various ways. For example, the first manipulation unit 123a may be used by the user to provide an input to a menu, home key, cancel, search, or the like, and the second manipulation unit 123b may be used by the user to provide an input to control a volume level being output from the first or second audio output modules 152a or 152b, to switch to a touch recognition mode of the display unit 151, or the like.

As another example of the user input unit 123, a rear input unit may be located on the rear surface of the terminal body. The rear input unit can be manipulated by a user to provide input to the mobile terminal 100. The input may be used in a variety of different ways. For example, the rear input unit may be used by the user to provide an input for power on/off, start, end, scroll, control volume level being output from the first or second audio output modules 152a or 152b, switch to a touch recognition mode of the display unit 151, and the like. The rear input unit may be configured to permit touch input, a push input, or combinations thereof.

The rear input unit may be located to overlap the display unit 151 of the front side in a thickness direction of the terminal body. As one example, the rear input unit may be located on an upper end portion of the rear side of the terminal body such that a user can easily manipulate it using a forefinger when the user grabs the terminal body with one hand. Alternatively, the rear input unit can be positioned at most any location of the rear side of the terminal body.

Embodiments that include the rear input unit may implement some or all of the functionality of the first manipulation unit 123a in the rear input unit. As such, in situations where the first manipulation unit 123a is omitted from the front side, the display unit 151 can have a larger screen. As a further alternative, the mobile terminal 100 may include a finger scan sensor which scans a user's fingerprint. The controller 180 can then use fingerprint information sensed by the finger scan sensor as part of an authentication procedure. The finger scan sensor may also be installed in the display unit 151 or implemented in the user input unit 123.

The microphone 122 is shown located at an end of the mobile terminal 100, but other locations are possible. If desired, multiple microphones may be implemented, with such an arrangement permitting the receiving of stereo sounds. The interface unit 160 may serve as a path allowing the mobile terminal 100 to interface with external devices. For example, the interface unit 160 may include one or more of a connection terminal for connecting to another device (for example, an earphone, an external speaker, or the like), a port for near field communication (for example, an Infrared Data Association (IrDA) port, a Bluetooth port, a wireless LAN port, and the like), or a power supply terminal for supplying power to the mobile terminal 100. The interface unit 160 may be implemented in the form of a socket for accommodating an external card, such as Subscriber Identification Module (SIM), User Identity Module (UIM), or a memory card for information storage.

The second camera 121b is shown located at the rear side of the terminal body and includes an image capturing direction that is substantially opposite to the image capturing direction of the first camera unit 121a. If desired, second camera 121a may alternatively be located at other locations, or made to be moveable, in order to have a different image capturing direction from that which is shown.

The second camera 121b can include a plurality of lenses arranged along at least one line. The plurality of lenses may also be arranged in a matrix configuration. The cameras may be referred to as an “array camera.” When the second camera 121b is implemented as an array camera, images may be captured in various manners using the plurality of lenses and images with better qualities.

As shown in FIG. 1C, a flash 124 is shown adjacent to the second camera 121b. When an image of a subject is captured with the camera 121b, the flash 124 may illuminate the subject. As shown in FIG. 1C, the second audio output module 152b can be located on the terminal body. The second audio output module 152b may implement stereophonic sound functions in conjunction with the first audio output module 152a, and may be also used for implementing a speaker phone mode for call communication.

At least one antenna for wireless communication may be located on the terminal body. The antenna may be installed in the terminal body or formed by the case. For example, an antenna which configures a part of the broadcast receiving module 111 may be retractable into the terminal body. Alternatively, an antenna may be formed using a film attached to an inner surface of the rear cover 103, or a case that includes a conductive material.

A power supply unit 190 for supplying power to the mobile terminal 100 may include a battery 191, which is mounted in the terminal body or detachably coupled to an outside of the terminal body. The battery 191 may receive power via a power source cable connected to the interface unit 160. Also, the battery 191 can be recharged in a wireless manner using a wireless charger. Wireless charging may be implemented by magnetic induction or electromagnetic resonance.

The rear cover 103 is shown coupled to the rear case 102 for shielding the battery 191, to prevent separation of the battery 191, and to protect the battery 191 from an external impact or from foreign material. When the battery 191 is detachable from the terminal body, the rear case 103 may be detachably coupled to the rear case 102.

An accessory for protecting an appearance or assisting or extending the functions of the mobile terminal 100 can also be provided on the mobile terminal 100. As one example of an accessory, a cover or pouch for covering or accommodating at least one surface of the mobile terminal 100 may be provided. The cover or pouch may cooperate with the display unit 151 to extend the function of the mobile terminal 100. Another example of the accessory is a touch pen for assisting or extending a touch input to a touch screen.

A communication system which is operable with the variously described mobile terminals will now be described in more detail. Such a communication system may be configured to utilize any of a variety of different air interfaces and/or physical layers. Examples of such air interfaces utilized by the communication system include Frequency Division Multiple Access (FDMA), Time Division Multiple Access (TDMA), Code Division Multiple Access (CDMA), Universal Mobile Telecommunications System (UMTS) (including, Long Term Evolution (LTE), LTE-A (Long Term Evolution-Advanced)), Global System for Mobile Communications (GSM), and the like.

By way of a non-limiting example only, further description will relate to a CDMA communication system, but such teachings apply equally to other system types including a CDMA wireless communication system as well as OFDM (Orthogonal Frequency Division Multiplexing) wireless communication system. A CDMA wireless communication system generally includes one or more mobile terminals (MT or User Equipment, UE) 100, one or more base stations (BSs, NodeB, or evolved NodeB), one or more base station controllers (BSCs), and a mobile switching center (MSC). The MSC is configured to interface with a conventional Public Switched Telephone Network (PSTN) and the BSCs. The BSCs are coupled to the base stations via backhaul lines. The backhaul lines may be configured in accordance with any of several known interfaces including, for example, E1/T1, ATM, IP, PPP, Frame Relay, HDSL, ADSL, or xDSL. Hence, the plurality of BSCs can be included in the CDMA wireless communication system.

Each base station may include one or more sectors, each sector having an omni-directional antenna or an antenna pointed in a particular direction radially away from the base station. Alternatively, each sector may include two or more different antennas. Each base station may be configured to support a plurality of frequency assignments, with each frequency assignment having a particular spectrum (e.g., 1.25 MHz, 5 MHz, etc.).

The intersection of sector and frequency assignment may be referred to as a CDMA channel. The base stations may also be referred to as Base Station Transceiver Subsystems (BTSs). In some cases, the term “base station” may be used to refer collectively to a BSC, and one or more base stations. The base stations may also be denoted as “cell sites.” Alternatively, individual sectors of a given base station may be referred to as cell sites.

A broadcasting transmitter (BT) transmits a broadcast signal to the mobile terminals 100 operating within the system. The broadcast receiving module 111 of FIG. 1A is typically configured inside the mobile terminal 100 to receive broadcast signals transmitted by the BT. Global Positioning System (GPS) satellites for locating the position of the mobile terminal 100, for example, may cooperate with the CDMA wireless communication system. Useful position information may be obtained with greater or fewer satellites than two satellites. It is to be appreciated that other types of position detection technology, (i.e., location technology that may be used in addition to or instead of GPS location technology) may alternatively be implemented. If desired, at least one of the GPS satellites may alternatively or additionally be configured to provide satellite DMB transmissions.

The location information module 115 is generally configured to detect, calculate, or otherwise identify a position of the mobile terminal. As an example, the location information module 115 may include a Global Position System (GPS) module, a Wi-Fi module, or both. If desired, the location information module 115 may alternatively or additionally function with any of the other modules of the wireless communication unit 110 to obtain data related to the position of the mobile terminal.

A typical GPS module 115 can measure an accurate time and distance from three or more satellites, and accurately calculate a current location of the mobile terminal according to trigonometry based on the measured time and distances. A method of acquiring distance and time information from three satellites and performing error correction with a single satellite may be used. In particular, the GPS module may acquire an accurate time together with three-dimensional speed information as well as the location of the latitude, longitude and altitude values from the location information received from the satellites.

Furthermore, the GPS module can acquire speed information in real time to calculate a current position. Sometimes, accuracy of a measured position may be compromised when the mobile terminal is located in a blind spot of satellite signals, such as being located in an indoor space. In order to minimize the effect of such blind spots, an alternative or supplemental location technique, such as Wi-Fi Positioning System (WPS), may be utilized.

The Wi-Fi positioning system (WPS) refers to a location determination technology based on a wireless local area network (WLAN) using Wi-Fi as a technology for tracking the location of the mobile terminal 100. This technology typically includes the use of a Wi-Fi module in the mobile terminal 100 and a wireless access point for communicating with the Wi-Fi module. The Wi-Fi positioning system may include a Wi-Fi location determination server, a mobile terminal, a wireless access point (AP) connected to the mobile terminal, and a database stored with wireless AP information.

The mobile terminal connected to the wireless AP may transmit a location information request message to the Wi-Fi location determination server. The Wi-Fi location determination server extracts the information of the wireless AP connected to the mobile terminal 100, based on the location information request message (or signal) of the mobile terminal 100. The information of the wireless AP may be transmitted to the Wi-Fi location determination server through the mobile terminal 100, or may be transmitted to the Wi-Fi location determination server from the wireless AP.

The information of the wireless AP extracted based on the location information request message of the mobile terminal 100 may include one or more of media access control (MAC) address, service set identification (SSID), received signal strength indicator (RSSI), reference signal received Power (RSRP), reference signal received quality (RSRQ), channel information, privacy, network type, signal strength, noise strength, and the like.

The Wi-Fi location determination server may receive the information of the wireless AP connected to the mobile terminal 100 as described above, and may extract wireless AP information corresponding to the wireless AP connected to the mobile terminal from the pre-established database. The information of any wireless APs stored in the database may be information such as MAC address, SSID, RSSI, channel information, privacy, network type, latitude and longitude coordinate, building at which the wireless AP is located, floor number, detailed indoor location information (GPS coordinate available), AP owner's address, phone number, and the like. In order to remove wireless APs provided using a mobile AP or an illegal MAC address during a location determining process, the Wi-Fi location determination server may extract only a predetermined number of wireless AP information in order of high RSSI.

Then, the Wi-Fi location determination server may extract (analyze) location information of the mobile terminal 100 using at least one wireless AP information extracted from the database. A method for extracting (analyzing) location information of the mobile terminal 100 may include a Cell-ID method, a fingerprint method, a trigonometry method, a landmark method, and the like.

The Cell-ID method is used to determine a position of a wireless AP having the largest signal strength, among peripheral wireless AP information collected by a mobile terminal, as a position of the mobile terminal. The Cell-ID method is an implementation that is minimally complex, does not require additional costs, and location information can be rapidly acquired. However, in the Cell-ID method, the precision of positioning may fall below a desired threshold when the installation density of wireless APs is low.

The fingerprint method is used to collect signal strength information by selecting a reference position from a service area, and to track a position of a mobile terminal using the signal strength information transmitted from the mobile terminal based on the collected information. In order to use the fingerprint method, it is common for the characteristics of radio signals to be pre-stored in the form of a database.

The trigonometry method is used to calculate a position of a mobile terminal based on a distance between coordinates of at least three wireless APs and the mobile terminal. In order to measure the distance between the mobile terminal and the wireless APs, signal strength may be converted into distance information, Time of Arrival (ToA), Time Difference of Arrival (TDoA), Angle of Arrival (AoA), or the like may be taken for transmitted wireless signals.

The landmark method is used to measure a position of a mobile terminal using a known landmark transmitter. In addition to these position location methods, various algorithms may be used to extract (analyze) location information of a mobile terminal. Such extracted location information may be transmitted to the mobile terminal 100 through the Wi-Fi location determination server, thereby acquiring location information of the mobile terminal 100.

The mobile terminal 100 can acquire location information by being connected to at least one wireless AP. The number of wireless APs required to acquire location information of the mobile terminal 100 may be variously changed according to a wireless communication environment within which the mobile terminal 100 is positioned.

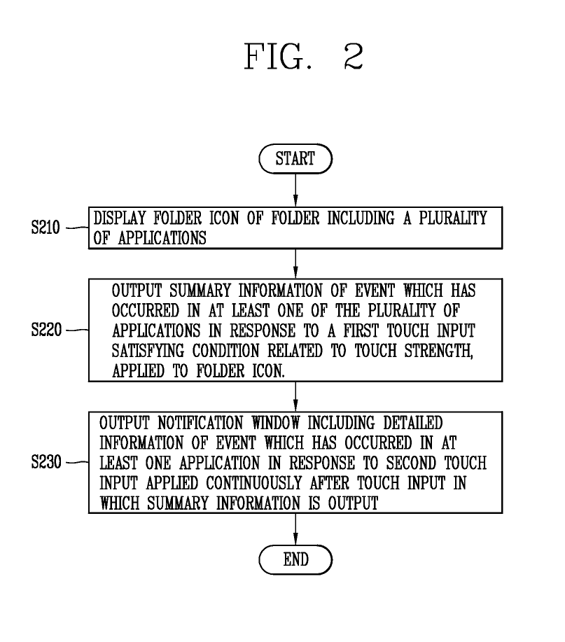

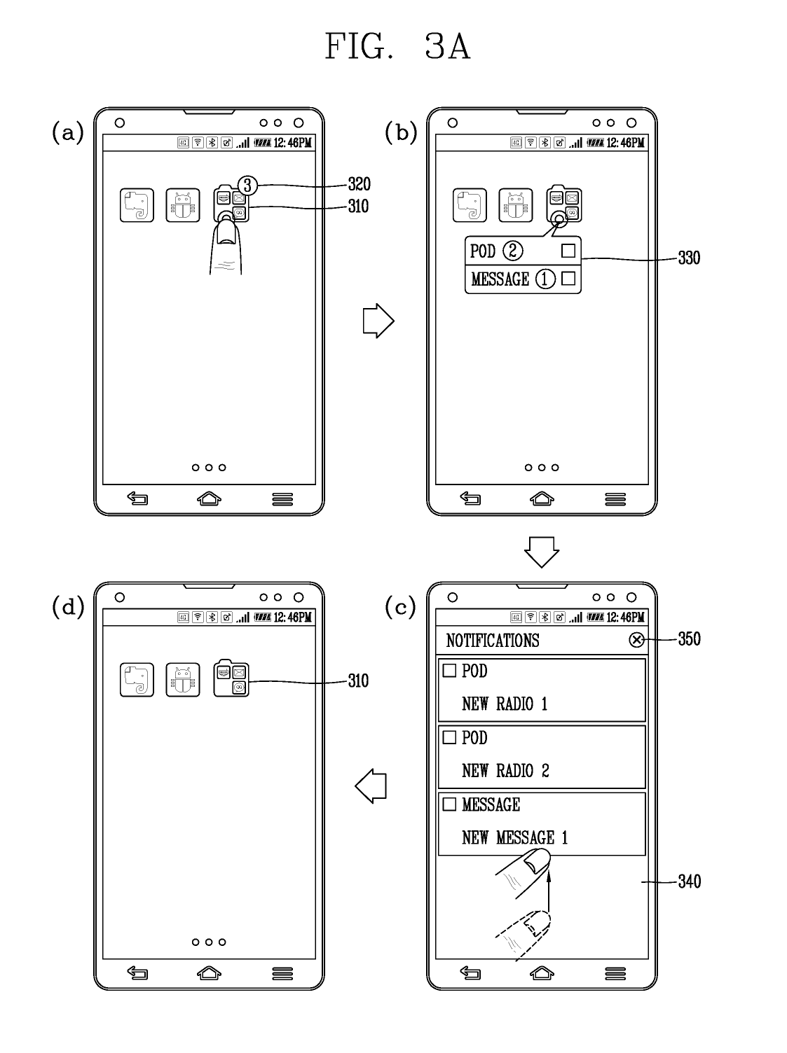

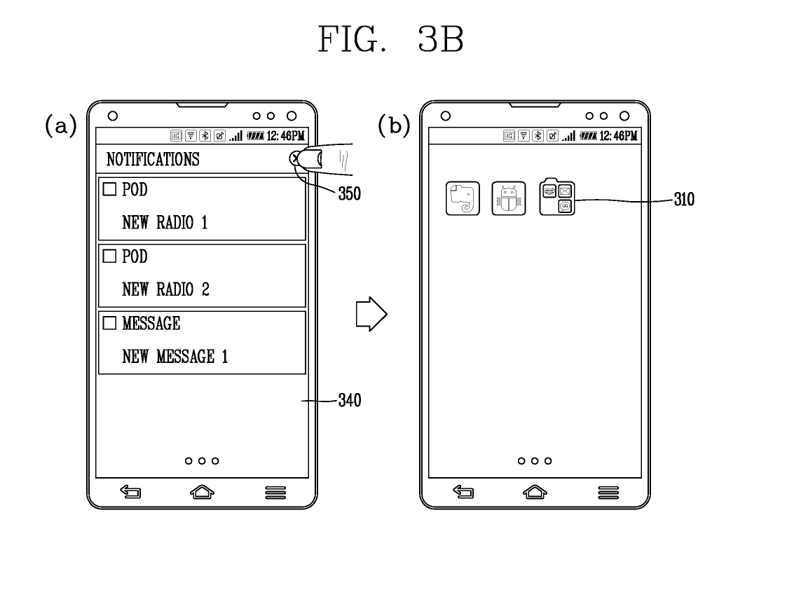

Next, FIG. 2 is a flow chart illustrating a method for providing a user interface managing notification information of an event that occurs in a mobile terminal according to an embodiment of the present disclosure. In addition, FIGS. 3A and 3B are conceptual views illustrating the user interface of FIG. 2.

Referring to FIG. 2, the controller 180 displays a folder icon of a folder including a plurality of applications (S210). The controller 180 can output a home screen page on the touch screen 151 in an idle state of the mobile terminal. The idle state refers to when an application installed in the mobile terminal is not executed as a foreground.

Referring to (a) of FIG. 3A, the home screen page includes an icon or a widget of application installed in the mobile terminal and the like. That is, the user can access an application installed in the mobile terminal through the home screen page.

When a user input is applied to a home key associated with a function of outputting the home screen page, the controller 180 can output the home screen page. In addition, when booting of the mobile terminal is completed, the controller 180 can output the home screen page. The home screen page may also be referred to as a menu page, an apps page, and the like.

Based on a control command from the user, the controller 180 can form some of a plurality of applications installed in the mobile terminal, as a folder. The controller 180 can also display a folder icon representing the folder on the home screen page. For example, the folder icon may have a briefcase image or a quadrangular image including reduced images of icons of applications included in the folder. The folder also includes a plurality of applications.

In addition, the controller 180 can sense occurrence of an event in at least one of the plurality of applications included in the folder. For example, the event can be message reception, call signal reception, an absent call, alarm, schedule notification, e-mail reception, reception of information through an application, etc.

When an event occurs in the mobile terminal, the controller 180 can output notification information indicating the occurrence of the event. The notification information indicates occurrence of the event and may include summary information related to the event and detailed information including specific information related to the event. That is, the notification information includes information related to the event and can be a graphic object or information which can execute a function related to the event.

As illustrated in (a) of FIG. 3A, when an event occurs in at least one application included in the folder, the controller 180 can output an icon indicating occurrence of the event on a folder icon 310 in an overlapping manner. Here, the icon indicating occurrence of the event can have a badge shape and be displayed to overlap a portion of the folder icon. Hereinafter, such an icon will be referred to as a badge icon 320.

The badge icon 320 represents the number of events which have occurred in the folder. That is, when two events occur in a first application and one event occurs in a second application, the badge icon can represent 3 as the number of events. Thus, the user can check the number of events which have occurred in the applications included in the folder.

However, the user cannot check in which of applications within the folder the events have occurred with the number of the badge icon. Thus, the user has to open the folder by applying a touch input to the folder icon to check the applications in which the events have occurred, one by one. For example, when a touch input is applied to the folder icon, the controller 180 can output icons of the applications included in the folder on the touch screen 151. Here, a badge icon indicating occurrence of the event may be displayed in each of the icons of the applications in which the event have occurred. Thus, the user can check the applications in which the events have occurred through the badge icon.

Thus, one embodiment of the present disclosure provides a user interface allowing the user to check information related to an event which occurs in an application included in a folder even without having to open the folder. Hereinafter, a method of providing such a user interface will be described in detail.

Referring back to FIG. 2, when a first touch input satisfying a condition related to a touch strength is applied to the folder icon, the controller 180 can output summary information of an event which has occurred in at least one of the plurality of applications (S220). The controller 180 can sense the first touch input satisfying the condition related to a touch strength with respect to a folder icon. The condition related to the touch strength can be that a touch pressure of the touch input is a reference value or greater. The touch input satisfying the condition related to the touch strength may also be referred to as a 3D touch or a force touch.

Referring to (a) and (b) of FIG. 3A, when a first touch input is applied to the folder icon 310, the controller 180 can output summary information of an event which has occurred in at least one of the plurality of applications. The summary information may information summarizing information related to the event. The summary information may include an icon of the application in which the event has occurred, a title of the application, and information of the number of events.

As illustrated in (b) of FIG. 3A, when the first touch input is applied, and when events have occurred in different applications, the controller 180 can output a list 330 including summary information of each application. Through this, the user can check the applications in which events have occurred, among the plurality of applications included in the folder, even without having to open the folder.

When the summary information is output, and when a second touch input following the first touch input is applied, the controller 180 can output a notification window 340 including detailed information of the event which has occurred in at least one application (S230).

Referring to (b) of FIG. 3A, when the summary information is output, the controller 180 can sense that the second touch input is applied continuously after the first touch input. The second touch input may be a drag input having a preset direction. For example, the drag input may be oriented downwards or upwards.

In addition, the second touch input may not follow the first touch input. For example, the second touch input may be a drag input applied separately from the first touch input, when the first touch input is maintained.

Referring to (c) of FIG. 3A, when the second touch input is applied, the controller 180 can output the notification window 340 including detailed information of the event which has occurred in at least one of the applications. The detailed information may include contents of the event, contact information related to the event, information of time at which the event has occurred, and the like, as well as the summary information.

Further, the notification window 340 may include detailed information of the events which have occurred in a plurality of applications included in a specific folder selected by the user to manage notification information indicating occurrence of the events by folders. That is, the notification window 340 does not include detailed information of an event which has occurred in another application installed in the mobile terminal. Thus, the user can collectively check only events which have occurred in a specific folder through the notification window 340.

Also, the notification window 340 can provide detailed information of different events regarding different folders. That is, when a first folder is selected, the controller 180 can output detailed information of an event which has occurred in at least one application included in the first folder on the notification window 340, and when a second folder different from the first folder is selected, the controller 180 can output detailed information of an event which as occurred in at least one application included in the second folder, on the notification window 340. Thus, the user can check information of the event included in each folder.

In addition, the notification window 340 can be output on currently output screen information in an overlapping manner. The controller 180 can also stop displaying the notification window 340 on the touch screen 151 based on a user control command. For example, when an upward drag input is applied, the controller 180 can stop displaying the notification window 340 on the touch screen 151. Here, previous screen information before the notification window 340 can be displayed on the touch screen 151. For example, as illustrated in (d) of FIG. 3A, the home screen page can be displayed on the touch screen 151.

When an event occurs, the controller 180 can set the event to a non-read state, and when contents related to the event is executed, the controller 180 can change the event from a non-read state to a read state. The read state is when a function related to the event is executed and an execution screen of the function related to the event is output on the touch screen 151. The non-read state refers to a state before the function related to the event is executed.

When the notification window 340 is output, the controller 180 can set the event which has occurred in the folder to the read state. That is, when the notification window 340 is output, the controller 180 can set the event to the read state, although a function related to the event is not executed. When the event is set to the read state, the controller 180 can not output the badge icon indicating occurrence of the event any longer.

Referring to (d) of FIG. 3A, when the event is set to the read state, the controller 180 can stop displaying the badge icon 320 indicating occurrence of the event. Thus, the user may not check the notification information related to the event which has occurred in at least one of the applications included in the folder any longer.

In contrast, the controller 180 can maintain the event included in the notification window 340 in the non-read state although the notification window 340 is output. Here, the badge icon 320 can continue to be output. When detailed information of the event included in the notification window 340 is deleted, the controller 180 can change the deleted event to the read state.

In more detail, referring to (a) of FIG. 3B, when a touch input is applied to a deletion button 350 associated with a function of deleting detailed information of the event included in the notification window 340, the controller 180 can delete detailed information of the event included in the notification window 340. Here, the detailed information of the event may not be further displayed on the notification window 340.

Also, when detailed information related to the event included in the notification window 340 is deleted, the controller 180 can change the event from the non-read state to the read state. As illustrated in (b) of FIG. 3B, in this instance, the controller 180 can stop displaying the badge icon 320, which has been displayed on the folder icon 310 in an overlapping manner. Thus, the notification information of the events which have occurred in different applications included in the folder may be deleted at a time. Therefore, the user can easily make the badge icon representing occurrence of an undesired event disappear.

In the above, the method of outputting a notification window by folders and a method of changing a read state of an event using the notification window have been described. Thus, in the present disclosure, notification information related to various events that occur in the mobile terminal and contents of the events can be effectively managed. Also, in the present disclosure, a notification icon can be easily deleted by changing a read state of events of different applications included in a folder at a time. Thus, an unnecessary notification icon is not displayed.

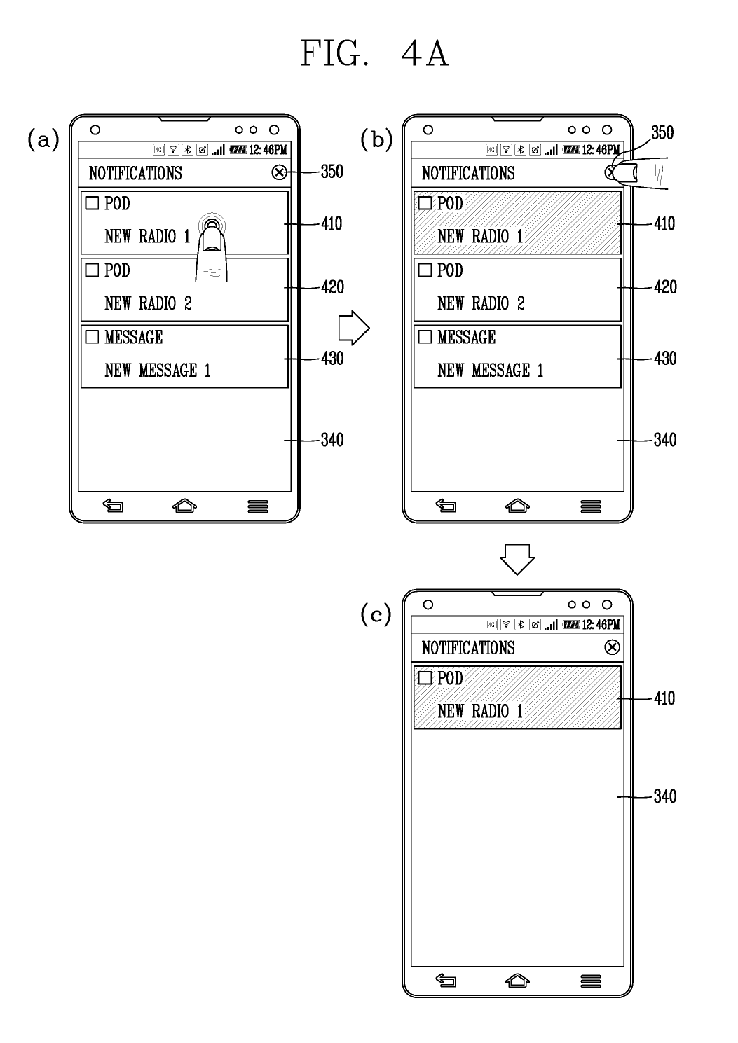

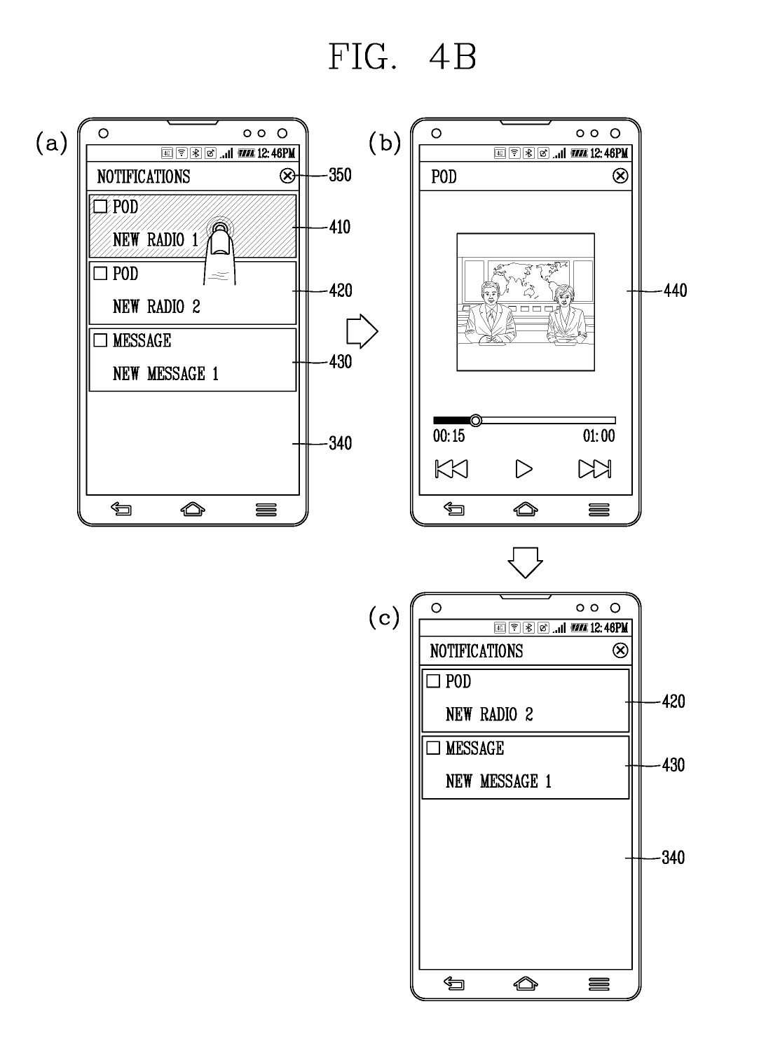

Hereinafter, a method of executing a function of storing an event using detailed information included in a notification window in the mobile terminal according to an embodiment of the present disclosure will be described. In particular, FIGS. 4A and 4B are conceptual views illustrating a method of executing a storage function.

When a touch input satisfying a condition related to a touch strength is applied to detailed information of an event included in a notification window, the controller 180 can execute an event storage function. The storage function is a function of setting such that notification information indicating occurrence of an event may not be deleted, in order to execute a function related to the event.

In more detail, referring to (a) of FIG. 4A, the controller 180 can sense that a touch input satisfying a condition related to a touch strength is applied to detailed information 410 among pieces of detailed information 410, 420, and 430 included in the notification window 340. The controller 180 can execute the storage function such that the specific detailed information 410 may not be deleted.

In this instance, as illustrated in (b) of FIG. 4A, the controller 180 can display the specific detailed information 410 included in the notification window 340 such that the specific detailed information 410 is visually differentiated from the other detailed information 420 and 430.

As illustrated in (c) of FIG. 4A, when a touch input is applied to a deletion icon 350 for deleting detailed information of the event included in the notification window 340, the controller 180 can delete the other detailed information 420 and 430 excluding the specific detailed information 410. Thus, through the specific detailed information 410, the user can execute a function related to the event indicated by the specific detailed information 410 later.

In addition, although the storage function is executed, if the function related to the event indicated by the specific detailed information 410 is executed, the controller 180 can make the specific detailed information 410 disappear from the notification window 340.

As illustrated in (a) of FIG. 4B, when a touch input is applied to the specific detailed information 410, the controller 180 can execute the function related to the event indicated by the specific detailed information 410. In this instance, as illustrated in (b) of FIG. 4B, an executed screen 440 of the event indicated by the specific detailed information 410 can be output on the touch screen 151.

Here, the controller 180 can set the event indicated by the specific detailed information 410 to a read state from a non-read state. Also, as illustrated in (c) of FIG. 4B, the controller 180 can make the specific detailed information 410 indicating the event switched to the read state disappear from the display unit. That is, the controller 180 can release the setting information such that the specific detailed information 410 is not deleted.

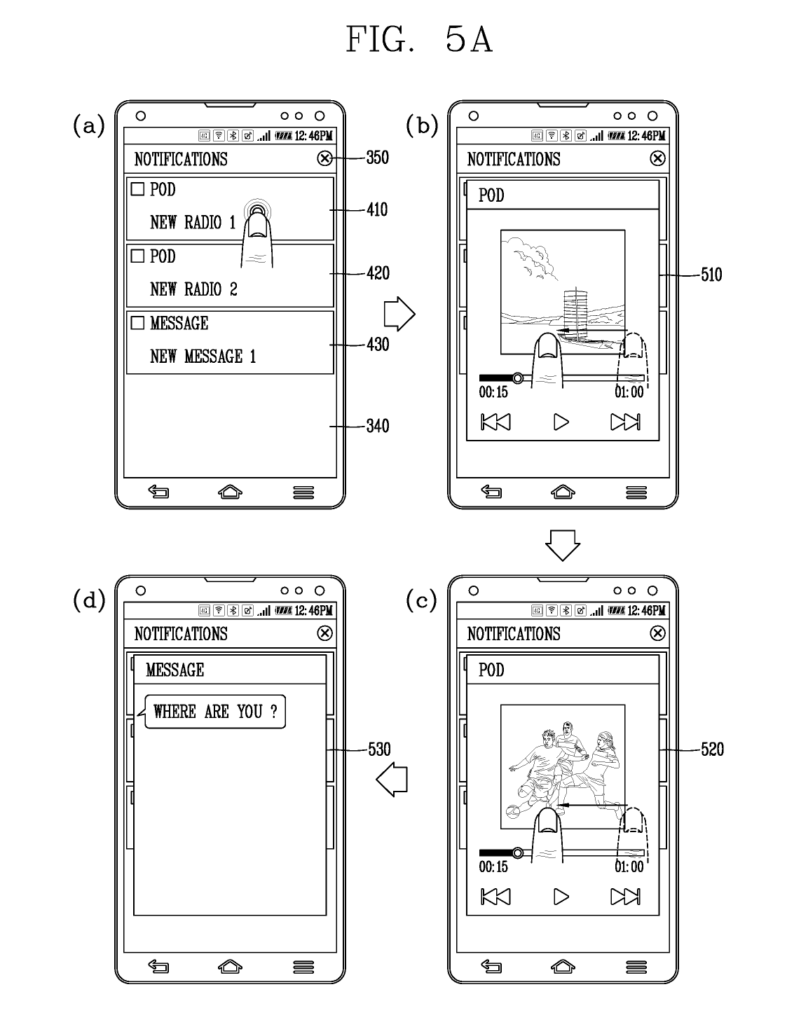

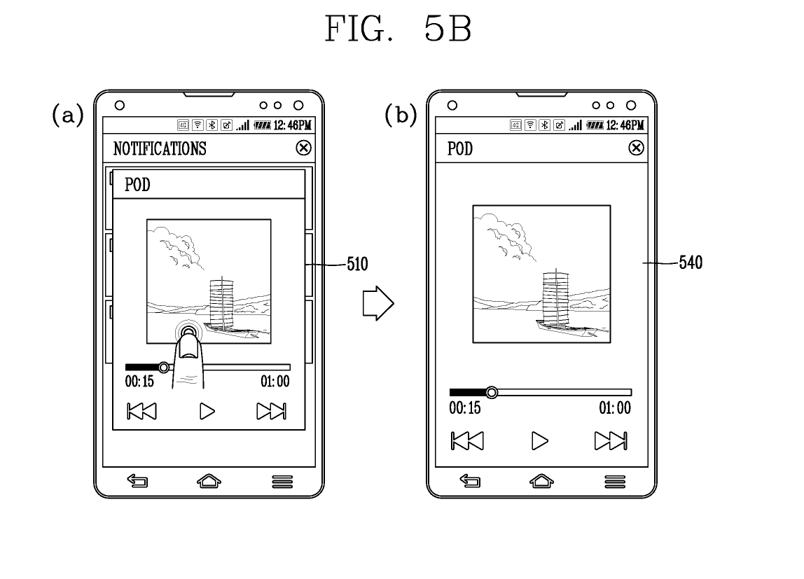

In the above, the method of executing the storage function regarding notification information related to an event has been described. Hereinafter, a method of providing a preview screen using detailed information included in a notification window will be described. In particular, FIGS. 5A and 5B are conceptual views illustrating a method of providing a preview screen using detailed information included in a notification window.

When a preset type touch input is applied to detailed information included in the notification window, the controller 180 can execute a function related to an event indicated by the detailed information. For example, when a short-touch input is applied to a specific detailed information, the controller 180 can execute an application related to an event indicated by the specific detailed information. In another example, referring to (a) of FIG. 5A, when a touch input satisfying a condition related to a touch strength is applied to the first detailed information 410, the controller 180 can output an execution screen of an application related to an event indicated by the first detailed information 410, as a preview screen 510. The preview screen 510 is obtained by reducing an execution screen of the application, before the application is executed. Thus, the user can determine whether to execute the application through the preview screen, before executing the application.

When a swipe input is applied to the preview screen, the controller 180 can sequentially output preview screens of an event indicated by detailed information included in the notification window. Here, the output order of the preview screens can be in the order in which pieces of detailed information are displayed on the notification window 340. The display order of the pieces of detailed information can be determined by an event occurrence time.

For example, referring to (b) of FIG. 5A, the controller 180 can sense that a swipe input is applied to a preview screen 510 corresponding to the first detailed information 410. Here, as illustrated in (c) of FIG. 5A, the controller 180 can output a preview screen 520 corresponding to second detailed information 520. The preview screen 520 corresponding to the second detailed information 420 may be a preview screen of an application related to an event indicated by the second detailed information 420.

The first detailed information 410 and the second detailed information 420 may relate to the same application. For example, both the first detailed information 410 and the second detailed information 420 may be music applications. However, when the first detailed information 410 is selected, the controller 180 can execute a music application using the first detailed information 410, and when the second detailed information 420 is selected, the controller 180 can executed the music application using the second detailed information 420. Thus, the preview screens may be different. In addition, the controller 180 can switch preview screens within the same application and also switch preview screens between different applications.

Referring to (c) and (d) of FIG. 5A, when a touch input is applied to the preview screen of the music application, the controller 180 can display a preview screen of a message application. When a touch input satisfying a condition related to a touch strength is applied to a preview screen, the controller 180 can execute an application indicated by the preview screen.

For example, as illustrated in (a) and (b) of FIG. 5B, when a touch input satisfying a condition related to a touch strength is applied to the preview screen 510 corresponding to the first detailed information 410, the controller 180 can execute an application 540 related to an event indicated by the first detailed information 410.

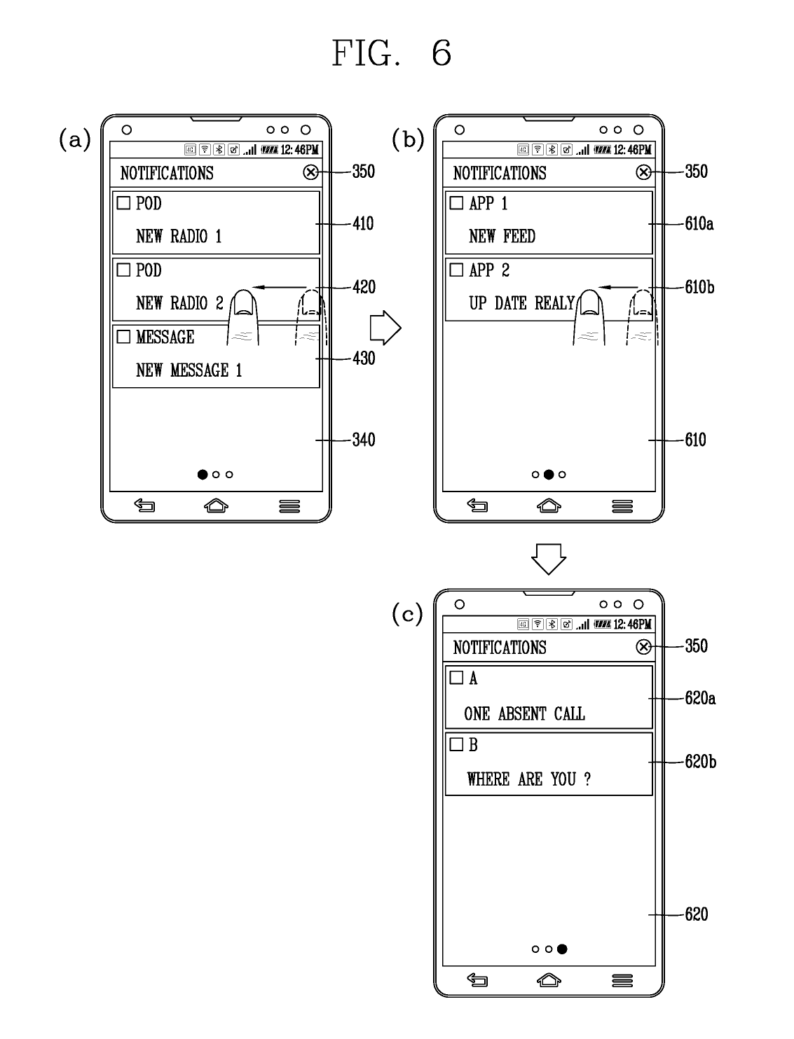

In the above, the preview screens of a function related to an event and execution method thereof using detailed information included in a notification window have been described. Hereinafter, a method of moving between notification windows generated by different folders will be described. In particular, FIG. 6 is a conceptual view illustrating a method of moving between notification windows generated by different folders.

Referring to (a) of FIG. 6, the controller 180 can include pieces of detailed information 410, 420, and 430 of events which have occurred in an application included in a specific folder, in the notification window 340. As illustrated in (b) of FIG. 6, when a touch input satisfying a touch strength and a drag input following the touch input are applied to an edge of the notification window 340, the controller 180 can output a notification window 610 including detailed information 610a and 610b of an event which has occurred in an application included in a folder other than the specific folder. That is, notification information can be checked by folders, and although a folder is not directly selected, contents of an event which has occurred in another folder may also be checked.

Further, the controller 180 can generate a notification window 620 collectively providing only events related to a phone number set as a bookmark. The phone number set as a bookmark may be set by the user. For example, as illustrated in (c) of FIG. 6, the controller 180 can output the notification window 620 including a call signal 620a received from the phone number set as the bookmark or detailed information 620b related to a message based on a user control command. That is, notification information can be provided by folders and notification information also be provided by bookmarks set by the user.

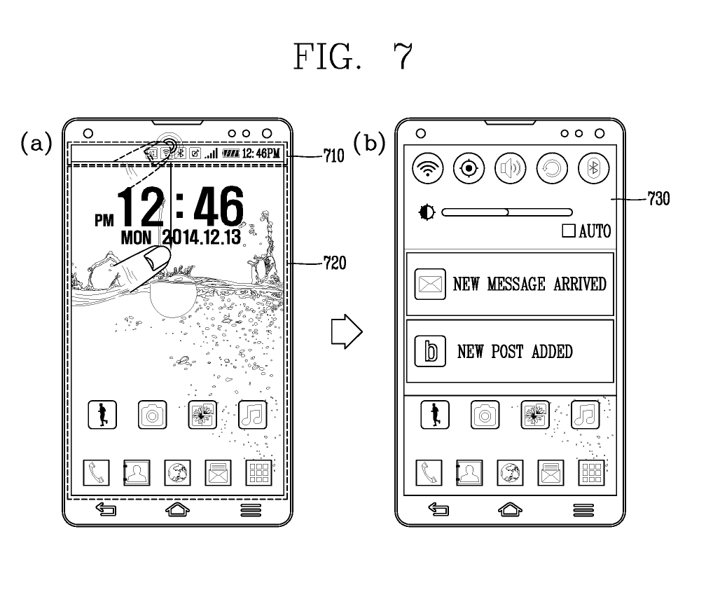

In the above, the method of moving between notification windows generated by different folders has been described. Hereinafter, a method of outputting a notification window using a state display region will be described. In particular, FIG. 7 is a conceptual view illustrating a method of outputting a notification window using a state display region.

As illustrated in (a) of FIG. 7, the touch screen 151 may include a first region 710 displaying state information of the mobile terminal and a second region 720 displaying a home screen page. The first region 710 can display a remaining battery capacity, time, communication state information, Bluetooth connection information, notification output type information, and the like, as state information of the mobile terminal. The first region 710 can be displayed in an upper end of the touch screen 151 and operate separately from the second region 720. The first region 710 may be referred to as a state display region or a state display bar.

The second region 720 can display a home screen page or an execution screen of an application. For example, when the mobile terminal is in an idle state, the controller 180 can display the home screen page in the second region 720, and when a specific application is being executed in the mobile terminal, the controller 180 can display an execution screen of the specific application in the second region 720.

In the present disclosure, different notification window can be output based on different touch inputs applied to the first region 710. In more detail, when a drag input is applied to the first region 710, the controller 180 can output a state display window. The state display window can include notification information of an event which has occurred in every application installed in the mobile terminal, information related to an environment setting of the mobile terminal, and the like.

Further, a notification window collectively providing only notification information related to an event which occurs in an application satisfying a preset condition can be generated. For example, the controller 180 can generate a notification window collectively providing only notification information related to an event which occurs in a frequently used application. In this instance, the controller 180 can extract a frequently used application according to usage information of an application, and when an event occurs in the extracted application, the controller 180 can include notification information indicating occurrence of the event, in the notification window. The usage information may include the number of use, a use time, a use period, and the like.

As illustrated in (a) and (b) of FIG. 7, when a touch input satisfying a condition related to a touch strength and a drag input following the touch input are applied to the first region 710, the controller 180 can output a notification window 730 including notification information related to an event which has occurred in the frequently used application. Thus, the user does not view unnecessary notification information.

In the above, the condition related to usage information of an application has been described as an example, but the present disclosure is not limited thereto. For example, the preset condition may be a condition related to a specific position and a condition related to a specific time. Also, the user can directly select an application in which notification information is displayed on the notification window.

In the above, the method of providing notification information of an event which has occurred in applications satisfying various conditions has been described. As described above, since the mobile terminal according to an embodiment of the present disclosure provides a notification window collectively providing pieces of notification information related to events which have occurred in applications included in folders, notification information of the events may be effectively managed by folders.

Also, in the mobile terminal according to an embodiment of the present disclosure, since the user can check pieces of notification information regarding events which have occurred in different applications at a time through a notification window provided by folders, notification of the applications included in the folders may be more conveniently checked.

The computer-readable medium includes any type of recording device in which data that can be read by a computer system is stored. The computer-readable medium may be, for example, a hard disk drive (HDD), a solid state disk (SSD), a silicon disk drive (SDD), a ROM, a RAM, a CD-ROM, a magnetic tape, a floppy disk, an optical data storage device, and the like. The computer-readable medium also includes implementations in the form of carrier waves (e.g., transmission via the Internet). Also, the computer may include the controller 180 of the terminal. Thus, the foregoing detailed description should not be interpreted limitedly in every aspect and should be considered to be illustrative. The scope of the present invention should be determined by reasonable interpretations of the attached claims and every modification within the equivalent range are included in the scope of the present invention.

The foregoing embodiments and advantages are merely exemplary and are not to be considered as limiting the present disclosure. The present teachings can be readily applied to other types of apparatuses. This description is intended to be illustrative, and not to limit the scope of the claims. Many alternatives, modifications, and variations will be apparent to those skilled in the art. The features, structures, methods, and other characteristics of the exemplary embodiments described herein may be combined in various ways to obtain additional and/or alternative exemplary embodiments.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds are therefore intended to be embraced by the appended claims.

What is claimed is:

1. A mobile terminal comprising:
a touch screen configured to display a folder icon of a folder including a plurality of applications; and
a controller configured to:
in response to a first force touch input having a specific touch strength applied to the folder icon, display summary information of an event which occurred in at least one application of the plurality of applications, and
in response to a first non-force touch input applied after the first force touch input, display a notification window including detailed information of the event which has occurred in at least one application of the plurality of applications.

2. The mobile terminal of claim 1, wherein the controller is further configured to:
when the event occurs in the at least one application included in the folder, display a badge image indicating the occurrence of the event on the folder icon in an overlapping manner, and
when the notification window is displayed, stop displaying the badge icon.

3. The mobile terminal of claim 1, wherein the controller is further configured to:
set a storage function to a particular detailed information for the event included in the notification window in response to a second force touch input on the particular detailed information for preventing the particular detailed information from being deleted from the notification window.

4. The mobile terminal of claim 3, wherein the controller is further configured to:
when a command for deleting the detailed information included in the notification window is input, delete only detailed information other than the particular detailed information to which the storage function has been set.

5. The mobile terminal of claim 3, wherein the controller is further configured to:
when contents of the event for the particular detailed information to which the storage function has been set is read, release the storage function set to the particular detailed information.

6. The mobile terminal of claim 1, wherein the controller is further configured to:
when a second force touch input is applied to a particular detailed information included in the notification window, display a preview of contents of the event indicated by the particular detailed information.

7. The mobile terminal of claim 6, wherein the controller is further configured to:
when a preset type touch input is applied to the preview, sequentially display previews of the contents of the event included in the notification window.

8. The mobile terminal of claim 6, wherein the controller is further configured to:
maintain the contents of the event for the particular detailed information, in a non-read state even though the preview of the particular detailed information is displayed.

9. The mobile terminal of claim 1, wherein the controller is further configured to:
when a swipe touch having a preset direction is applied to the notification window, display detailed information related to an event which has occurred in a new application, rather than the plurality of applications included in the folder.

10. The mobile terminal of claim 9, wherein the new application is any one of an application included in another folder and an application corresponding to a same category as that of the plurality of applications included in the folder.

11. The mobile terminal of claim 1, wherein the touch screen includes a state display region displaying state information of the mobile terminal, and
when a second force touch input and a second non-force touch input following the second force touch input are applied to the state display region, the controller is further configured to display the notification window including detailed information related to an event satisfying a preset condition.

12. The mobile terminal of claim 11, wherein the preset condition is related to a use aspect of an application in which the event has occurred.

13. A method of controlling a mobile terminal, the method comprising:
displaying, via a touch screen of the mobile terminal. a folder icon of a folder including a plurality of applications;
in response to a first force touch input having a specific touch strength applied to the folder icon, displaying, via the touch screen, summary information of an event which occurred in at least one application of the plurality of applications; and
in response to a first non-force touch input applied after the first force touch input, displaying, via the touch screen, a notification window including detailed information of the event which has occurred in at least one application of the plurality of applications.

14. The method of claim 13, further comprising:
when the event occurs in the at least one application included in the folder, displaying, via the touch screen, a badge image indicating the occurrence of the event on the folder icon in an overlapping manner, and
when the notification window is displayed, stopping, via a controller of the mobile terminal, displaying the badge icon.

15. The method of claim 13, further comprising:
setting, via a controller of the mobile terminal. a storage function to a particular detailed information for the event included in the notification window in response to a second force touch input on the particular detailed information for preventing the particular detailed information from being deleted from the notification window.

16. The method of claim 15, further comprising:
when a command for deleting the detailed information included in the notification window is input, deleting, via the controller, only detailed information other than the particular detailed information to which the storage function has been set.

17. The method of claim 15, further comprising:
when contents of the event for the particular detailed information to which the storage function has been set is read, releasing, via the controller, the storage function set to the particular detailed information.

18. The method of claim 13, further comprising:
when a second force touch input is applied to a particular detailed information included in the notification window, displaying, via the touch screen, a preview of contents of the event indicated by the particular detailed information.

19. The method of claim 18, further comprising:
when a preset type touch input is applied to the preview, sequentially displaying previews of the contents of the event included in the notification window.

20. The method of claim 18, further comprising:
maintaining, via the controller, the contents of the event for the particular detailed information, in a non-read state even though the preview of the particular detailed information is displayed.
